(19) United States
(12) Patent Application Publication
(10) Pub. No.: US 2025/0338994 A1
(43) Pub. Date: Nov. 6, 2025

(54) Electric Cooking Pot

(71) Applicant: Byron Smith, Missouri City, TX (US)

(72) Inventor: Byron Smith, Missouri City, TX (US)

(21) Appl. No.: 18/653,543

(22) Filed: May 2, 2024

(51) Int. Cl. A47J 36/20; A47J 27/00; A47J 27/04; A47J 36/04; A47J 36/06; H05B 3/42

(52) U.S. Cl. CPC A47J 36/20; A47J 27/004; A47J 27/04; A47J 36/04; A47J 36/06; H05B 3/42; A47J 2027/043

(57) ABSTRACT

An electric cooking pot generally comprising a container, a lid, a strainer basket, a heating arrangement, and a sealing structure. The heating arrangement includes a heating element and a power cord connected to the heating element. The heating element is mounted in an aperture in the side of the container and positioned to project into a bottom portion of the container. The strainer basket includes support legs that are positioned to project out from the bottom of the strainer basket to support the strainer basket on the bottom of the container. The support legs are sufficiently long to create a heating space into which the heating element projects.

### (b) CROSS-REFERENCE TO RELATED APPLICATIONS

### Not Applicable

### (c) STATEMENT REGARDING FEDERALLY SPONSORED RESEARCH OR DEVELOPMENT

### Not Applicable

### (d) THE NAMES OF THE PARTIES TO A JOINT RESEARCH AGREEMENT

### Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

### Not Applicable

### (f) STATEMENT REGARDING PRIOR DISCLOSURES BY THE INVENTOR OR JOINT INVENTOR

### Not Applicable

### (g) BACKGROUND OF THE INVENTION

### (1) Field of the Invention.

The disclosure relates to cooking pots or steamers and more particularly pertains to a new electric cooking pot for boiling or steaming food. Many such devices have complex designs and are not very portable. Such devices are bulky and expensive.

### (2) Description of Related Art including information disclosed under 37 CFR 1.97 and 1.98.

The prior art relates to cooking pots or steamers. The prior art, as best understood, does not disclose a cooking pot with a removable strainer basket supported by support legs on the bottom of the pot with a heating element located inside the pot itself under the strainer basket adjacent the support legs.

### (h) BRIEF SUMMARY OF THE INVENTION

An embodiment of the disclosure meets the needs presented above in an electric cooking pot generally comprising a container, a lid, a strainer basket, a heating arrangement, and a sealing structure. The container includes a container mouth. The lid is designed to cover the container mouth. The strainer basket is designed to be inserted into the container. The heating arrangement is designed to heat water in the container. The heating arrangement includes a heating element and a power cord connected to the heating element. The heating element is mounted in an aperture in the side of the container and positioned to project into a bottom portion of the container essentially radially and parallel to the bottom of the container. The sealing structure is designed and positioned to seal around the heating element at the aperture to prevent water and/or steam from leaking out through the aperture. The strainer basket includes support legs that are positioned to project out from the bottom of the strainer basket to support the strainer basket on the bottom of the container. The support legs are sufficiently long to create a heating space between the bottom of the strainer basket and the bottom of the container into which the heating element projects to permit the heating element to heat the water in the container without contacting the strainer basket.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of an electric cooking pot according to an embodiment of the disclosure.

FIG. 2 is a side view of an embodiment of the disclosure.

FIG. 3 is a top view of an embodiment of the disclosure.

FIG. 4 is a bottom perspective view of a portion of an embodiment of the disclosure.

FIG. 5 is a cross-sectional view of an embodiment of the disclosure.

FIG. 6 is a side view of an embodiment of the disclosure in use.

### (j) DETAILED DESCRIPTION OF THE INVENTION

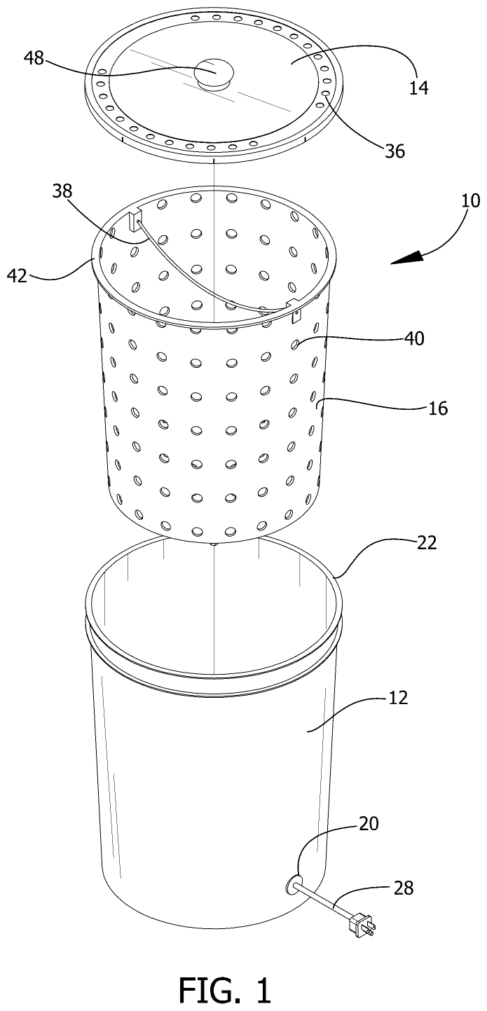

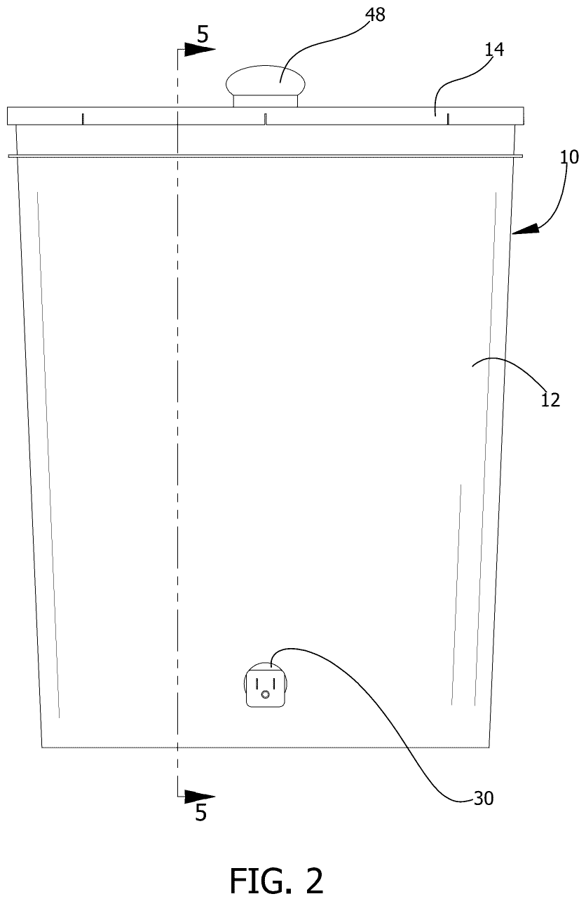

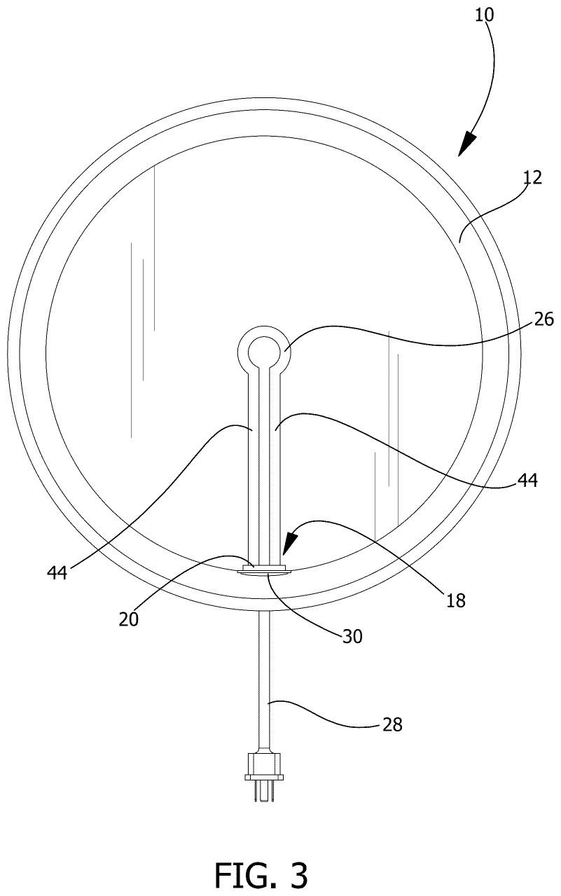

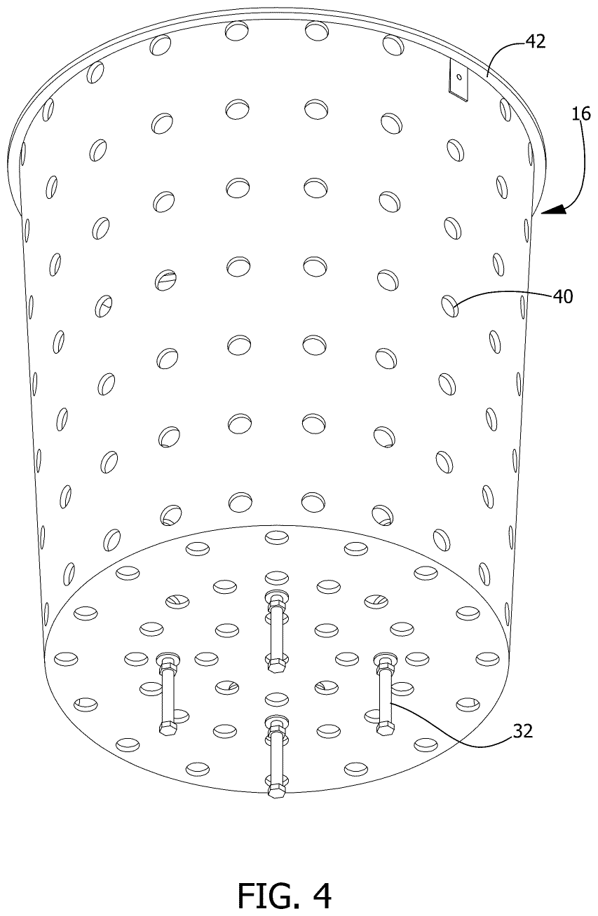

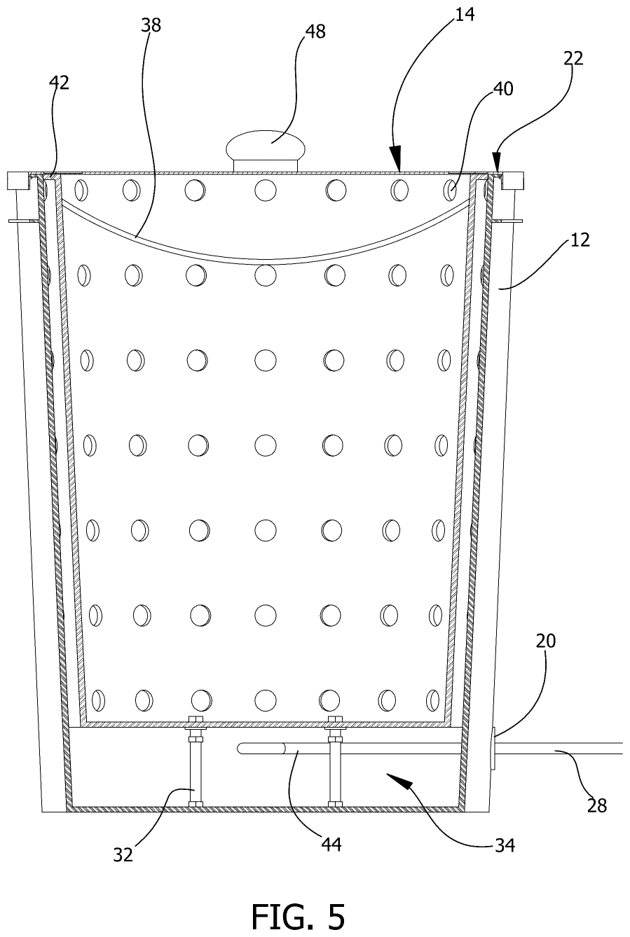

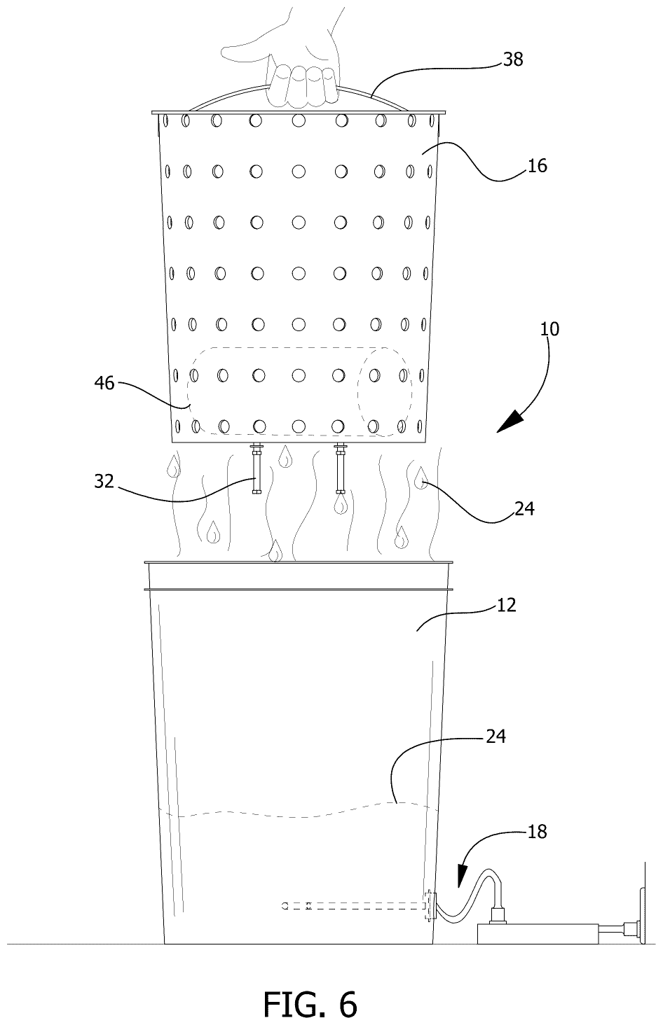

With reference now to the drawings, and in particular to FIGS. 1 through 6 thereof, a new electric cooking pot embodying the principles and concepts of an embodiment of the disclosure and generally designated by the reference numeral 10 will be described.

As best illustrated in FIGS. 1 through 6, the electric cooking pot 10 generally comprises a container 12, a lid 14, a strainer basket 16, a heating arrangement 18, and a sealing structure 20. The container 12 includes a container mouth 22. The lid 14 is designed to cover the container mouth 22. The strainer basket 16 is designed to be inserted into the container 12. The heating arrangement 18 is designed to heat water 24 in the container 12. The heating arrangement 18 includes a heating element 26 and a power cord 28 connected to the heating element 26. The heating element 26 is mounted in an aperture 30 in the side of the container 12 and positioned to project into a bottom portion of the container 12 essentially radially and parallel to the bottom of the container 12. The sealing structure 20 is designed and positioned to seal around the heating element 26 at the aperture 30 to prevent water 24 and/or steam from leaking out through the aperture 30. The strainer basket 16 includes support legs 32 that are positioned to project out from the bottom of the strainer basket 16 to support the strainer basket 16 on the bottom of the container 12. The support legs 32 are sufficiently long to create a heating space 34 between the bottom of the strainer basket 16 and the bottom of the container 12 into which the heating element 26 projects to permit the heating element 26 to heat the water 24 in the container 12 without contacting the strainer basket 16.

In accordance with at least one possible embodiment, the support legs 32 are spaced apart from one another a distance sufficient to permit the heating element 26 to project between adjacent support legs 32. In accordance with at least one possible embodiment, the lid 14 includes vent holes 36 to vent steam.

In accordance with at least one possible embodiment, the strainer basket 16 includes: a handle 38 to permit a user to lower and raise the strainer basket 16 into and out of the container 12, openings 40 in the side and/or bottom of the strainer basket 16 to permit flow of water 24 and/or steam into and out of the strainer basket 16, and a lip 42 designed to rest against the interior of the mouth 22 of the container 12 to center the strainer basket 16 in the container 12 with space between the exterior of the strainer basket 16 and the interior of the container 12.

In accordance with at least one possible embodiment, the lid 14 includes a knob 48 to permit a user to lift the lid 14 on and off of the container 12.

In accordance with at least one possible embodiment, the heating element 26 includes at least two heating rods 44 positioned essentially parallel to one another and connected at the ends thereof by a loop portion. The heating rods 44 allow the water 24 to be heated directly without the need to first heat the container 12.

In accordance with at least one possible embodiment, each of the container 12 and the strainer basket 16 includes food-grade, heat-resistant, plastic material. In accordance with at least one possible embodiment, the support legs 32 comprise food-grade, heat-resistant, plastic material and are integrally formed with the strainer basket 16. Using plastic material makes the entire device lightweight and portable.

In accordance with at least one possible embodiment, the support legs 32 are screwed or bolted to the strainer basket 16.

In accordance with at least one possible embodiment, the electric cooking pot 10 can be used to boil and/or steam food 46. The user can first plug in the power cord 28 and activate the heating arrangement 18, which can be done before or after the water 24, strainer basket 16, and food 46 are placed in the container 12. The user can fill at least the heating space 34 in the bottom of the container 12 with an amount of water 24 sufficient to surround the heating element 26. The user can insert the strainer basket 16 into the container 12 with the support legs 32 supporting the strainer basket 16. The user can then place the lid 14 onto the container 12. The heating element 26 then heats the water 24 and thereby boils and/or steams the food 46 in the strainer basket 16. Upon completion of boiling and/or steaming of the food 46, the user removes the lid 14 and lifts the strainer basket 16 with food 46 therein out of the container 12 while allowing excess water 24 to drain out of the strainer basket 16 and into the container 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electric cooking pot for boiling and/or steaming food comprising:
a container comprising a container mouth;
a lid being configured to cover said container mouth;
a strainer basket being configured to be inserted into said container;
a heating arrangement being configured to heat water in said container;
said heating arrangement comprising a heating element and a power cord connected to said heating element;
said heating element being mounted in an aperture in the side of said container and disposed to project into a bottom portion of said container essentially radially and parallel to the bottom of said container;
a sealing structure being configured and disposed to seal around said heating element at said aperture to prevent water and/or steam from leaking out through said aperture;
said strainer basket comprising support legs being disposed to project out from the bottom of said strainer basket to support said strainer basket on the bottom of said container; and
said support legs being sufficiently long to create a heating space between the bottom of said strainer basket and the bottom of said container into which said heating element projects to permit said heating element to heat the water in the container without contacting said strainer basket.

2. The electric cooking pot of claim 1, wherein said support legs are spaced apart from one another a distance sufficient to permit said heating element to project between adjacent support legs.

3. The electric cooking pot of claim 2, wherein said lid comprises vent holes to vent steam.

4. The electric cooking pot of claim 3, wherein said strainer basket comprises:
a handle to permit a user to lower and raise said strainer basket into and out of said container;
openings in the side and/or bottom of said strainer basket to permit flow of water and/or steam into and out of said strainer basket; and
a lip configured to rest against the interior of said mouth of said container to center said strainer basket in said container with space between the exterior of said strainer basket and the interior of said container.

5. The electric cooking pot of claim 4, wherein said lid comprises a knob to permit a user to lift said lid on and off of said container.

6. The electric cooking pot of claim 5, wherein said heating element comprises at least two heating rods disposed essentially parallel to one another and connected at the ends thereof by a loop portion.

7. The electric cooking pot of claim 6, wherein each of said container and said strainer basket comprises food-grade, heat-resistant, plastic material.

8. The electric cooking pot of claim 7, wherein said support legs comprise food-grade, heat-resistant, plastic material and are integrally formed with said strainer basket.

9. The electric cooking pot of claim 7, wherein said support legs are screwed or bolted to said strainer basket.

10. The electric cooking pot of claim 1, wherein said lid comprises vent holes to vent steam.

11. The electric cooking pot of claim 1, wherein said strainer basket comprises:
a handle to permit a user to lower and raise said strainer basket into and out of said container;
openings in the side and/or bottom of said strainer basket to permit flow of water and/or steam into and out of said strainer basket; and
a lip configured to rest against the interior of said mouth of said container to center said strainer basket in said container with space between the exterior of said strainer basket and the interior of said container.

12. The electric cooking pot of claim 1, wherein said lid comprises a knob to permit a user to lift said lid on and off of said container.

13. The electric cooking pot of claim 1, wherein said heating element comprises at least two heating rods disposed essentially parallel to one another and connected at the ends thereof by a loop portion.

14. The electric cooking pot of claim 1, wherein each of said container and said strainer basket comprises food-grade, heat-resistant, plastic material.

15. The electric cooking pot of claim 1, wherein said support legs comprise food-grade, heat-resistant, plastic material and are integrally formed with said strainer basket.

16. The electric cooking pot of claim 1, wherein said support legs are screwed or bolted to said strainer basket.

17. A method of boiling and/or steaming food using the electric cooking pot of claim 1, said method comprising:
plugging in said power cord and activating said heating arrangement;
filling at least the heating space in the bottom of said container with an amount of water sufficient to surround said heating element;
inserting said strainer basket into said container with said support legs supporting said strainer basket;
placing said lid onto said container;
heating the water with said heating element and thereby boiling and/or steaming food in said strainer basket;
upon completion of boiling and/or steaming of the food, removing said lid and lifting said strainer basket with food therein out of said container while allowing excess water to drain out of said strainer basket and into said container.
